(19) United States
(12) Patent Application Publication
(10) Pub. No.: US 2014/0360314 A1
(43) Pub. Date: Dec. 11, 2014

(54) CRANKSET AND BOTTOM BRACKET ASSEMBLY

(71) Applicant: Mark Bradley Sams, Boise, ID (US)

(72) Inventor: Mark Bradley Sams, Boise, ID (US)

(21) Appl. No.: 14/260,485

(22) Filed: Apr. 24, 2014

Related U.S. Application Data
(60) Provisional application No. 61/832,400, filed on Jun. 7, 2013.
(60) Provisional application No. 61/972,952, filed on Mar. 31, 2014.

(51) Int. Cl. B62M 3/00

(52) U.S. Cl. CPC B62M 3/003
USPC 74/594.2; 74/594.1; 74/594.4

(57) ABSTRACT

A crankset and bottom bracket assembly for a bicycle having a spindle. The crankset and bottom bracket assembly comprising a first crank. The first crank comprising a first ratchet mechanism configured for connection to the spindle at a first end. Wherein when the first ratchet mechanism is rotated in a first direction relative to the spindle, the pawl does not engage the tooth and the first crank freewheels relative to the spindle, and wherein when the first ratchet mechanism is rotated in a second direction relative to the spindle, the pawl engages the tooth and rotation of the first crank drives the rotation of the spindle.

### TECHNICAL FIELD

The disclosure generally relates to the field of bicycle crank sets.

### SUMMARY OF THE DISCLOSURE

Several exemplary crankset and bottom bracket assemblies are described herein.

A first exemplary crankset and bottom bracket assembly comprises a bottom bracket assembly configured for insertion into a bottom bracket shell of a bicycle frame. The bottom bracket assembly comprising a spindle, a first crank assembly and a second crank assembly. The spindle having a first end and a second end. The first crank assembly comprising a first crank. The first crank comprising a first ratchet mechanism configured for connection to the spindle at the first end. The first ratchet mechanism comprising a freewheel axle having at least one tooth, and a hub receiver having at least one pawl configured for engaging the tooth. When the first ratchet mechanism is rotated in a first direction relative to the spindle, the pawl does not engage the tooth and the first crank freewheels relative to the spindle. When the first ratchet mechanism is rotated in a second direction relative to the spindle, the pawl engages the tooth and rotation of the first crank drives the rotation of the spindle. The second crank assembly comprises a second crank. The second crank is configured for connection to the spindle at the second end. When the first crank freewheels, the second crank can be utilized to drive the spindle.

A second exemplary crankset and bottom bracket assembly comprises a bottom bracket assembly, a first crank assembly, and a second crank assembly. The bottom bracket assembly configured for insertion into a bracket shell of a bicycle frame. The bottom bracket assembly comprising a spindle having a first end and a second end. The first crank assembly comprising a first crank. The first crank comprising a first ratchet mechanism configured for connection to the spindle at the first end. The first ratchet mechanism comprising a freewheel axle having at least one tooth, and a hub receiver having at least one pawl configured for engaging the tooth. When the first ratchet mechanism is rotated in a first direction relative to the spindle, the pawl does not engage the tooth and the first crank freewheels relative to the spindle. When the first ratchet mechanism is rotated in a second direction relative to the spindle, the pawl engages the tooth and rotation of the first crank drives the rotation of the spindle. The second crank assembly comprises a second crank, the second crank configured for connection to the spindle at the second end.

These and other aspects of exemplary crankset and bottom bracket assemblies are set out in the claims, which are incorporated here by reference.

### BRIEF DESCRIPTION OF THE DRAWINGS

FIG. 1 is a perspective view of a third exemplary crankset and bottom bracket assembly as they might be in a turn.

FIG. 2 is a front perspective view of the exemplary crankset and bottom bracket assembly of FIG. 1.

FIG. 3 is a side perspective view of the exemplary crankset and bottom bracket assembly of FIG. 1.

FIG. 4 is a front perspective view of the exemplary crankset and bottom bracket assembly of FIG. 1, illustrating the crankset in a parallel position.

FIG. 5 is a side perspective view of the exemplary crankset and bottom bracket assembly of FIG. 1, illustrating the crankset in a parallel position.

FIG. 6 is an exploded view of the exemplary crankset and bottom bracket assembly of FIG. 1.

FIG. 7 is an exploded view of the first crankset assembly of the exemplary crankset and bottom bracket assembly of FIG. 1.

FIG. 8 is an exploded view of the second crankset assembly of the exemplary crankset and bottom bracket assembly of FIG. 1.

FIG. 9 is a partial, side view illustrating the hub of the second crankset assembly of the exemplary crankset and bottom bracket assembly of FIG. 1.

FIG. 10 is a partial, side view illustrating the second crankset assembly of the exemplary crankset and bottom bracket assembly of FIG. 1 in its engaged position.

FIG. 11 is a partial, side view illustrating the second crankset assembly of the exemplary crankset and bottom bracket assembly of FIG. 1 in its retracted position.

FIG. 12 is a partial, side view illustrating the first crankset assembly of the exemplary crankset and bottom bracket assembly of FIG. 1 in its engaged position.

FIG. 13 is a partial, side view illustrating the first crankset assembly of the exemplary crankset and bottom bracket assembly of FIG. 1 in its retracted position.

### DETAILED DESCRIPTION

The following description and the referenced drawings provide illustrative examples of that which the inventor regards as his invention. As such, the embodiments discussed herein are merely exemplary in nature and are not intended to limit the scope of the invention, or its protection, in any manner. Rather, the description and illustration of these embodiments serve to enable a person of ordinary skill in the relevant art to practice the invention.

The use of “e.g.,” “etc,” “for instance,” “in example,” “for example,” and “or” and grammatically related terms indicates non-exclusive alternatives without limitation, unless the context clearly dictates otherwise. The use of “including” and grammatically related terms means “including, but not limited to,” unless the context clearly dictates otherwise. The use of the articles “a,” “an” and “the” are meant to be interpreted as referring to the singular as well as the plural, unless the context clearly dictates otherwise. Thus, for example, reference to “a pawl” includes two or more such pawls, and the like. The use of “optionally,” “alternatively,” and grammatically related terms means that the subsequently described element, event or circumstance may or may not be present/occur, and that the description includes instances where said element, event or circumstance occurs and instances where it does not. The use of “preferred,” “preferably,” and grammatically related terms means that a specified element or technique is more acceptable than another, but not that such specified element or technique is a necessity, unless the context clearly dictates otherwise. The use of “exemplary” means “an example of” and is not intended to convey a meaning of an ideal or preferred embodiment. Words of approximation (e.g., “substantially,” “generally”), as used in context of the specification and figures, are intended to take on their ordinary and customary meanings which denote approximation, unless the context clearly dictates otherwise.

The term “ratchet mechanism,” as used herein, means a mechanical device that allows continuous linear or rotary motion in only one direction while preventing motion in the opposite direction, unless the context clearly dictates otherwise. Examples of ratchet mechanisms include, but are not limited to, ratchets, gear and pawl style ratchets, mechanical diodes, one-way clutches, sprag clutches, freewheels, clutches, and the like.

The term “bicycle,” as used herein, is not limiting to traditional bicycles. The term covers, but is not limited to, road bicycles, mountain bicycles, stationary bicycles, experimental vehicles, unicycles, and the like.

The term “rotation,” as used herein, refers to a crank assembly's movement relative to the spindle, unless the context clearly dictates otherwise.

A bicycle, often called a bike, is a human-powered, pedal-driven, single-track vehicle, having two wheels attached to a frame, one behind the other. The great majority of today's bicycles have a frame with upright seating. Such upright seating bicycles almost always feature a diamond frame—a truss consisting of two triangles: the front triangle and the rear triangle. The front triangle consists of the head tube, top tube, down tube, and seat tube. The head tube contains the headset, the set of bearings that allows the fork to turn smoothly for steering and balance. The top tube connects the head tube to the seat tube at the top, and the down tube connects the head tube to the bottom bracket. The rear triangle consists of the seat tube and paired chain stays and seat stays. The chain stays run parallel to the chain, connecting the bottom bracket to the rear dropout, where the axle for the rear wheel is held. The seat stays connect the top of the seat tube (at or near the same point as the top tube) to the rear fork ends.

A typical bicycle drive train includes at least one crankset having two cranks. Each crank supports a pedal at one end, and couples with the bottom bracket spindle adjacent the other end. These cranksets transfer energy exerted on the pedals by a rider to forward motion of the bicycle. Cranksets typically include one or more sprockets (chain rings) that engage a chain to transfer the rotary motion of the crankset to a rear wheel via one or more rear wheel sprockets.

The bottom bracket on a bicycle connects the crankset to the bicycle, and allows the crankset to rotate freely. It is not a “bracket” as such—it contains a spindle that the crankset attaches to and bearings that allow the spindle and cranks to rotate. The bottom bracket fits inside the bottom bracket shell. The bottom bracket shell is the portion of the bicycle's frame which connects the seat tube, down tube and chain stays.

A traditional bicycle has two cranks, one on each side of the bicycle, mounted one-hundred-eighty degrees apart. The cranks on a traditional bicycle are fixed, meaning if pressure is exerted on one pedal of the bicycle, the other pedal will move in a reciprocal motion. The cranks mount to the spindle and turn freely when pressure is exerted on either pedal. Pressure in a forward (clockwise) motion causes the spindle to turn a sprocket that, in turn, propels the bike in a forward direction. Conversely, pressure in a rearward (counterclockwise) motion causes the cranks to freewheel and, in turn, not propel the bike forward.

Disclosed are embodiments of a crankset and bottom bracket assembly for bicycles, and embodiments of a crankset for bicycles (collectively referred to as a “crankset and bottom bracket assembly” for the purpose of this disclosure).

Exemplary crankset and bottom bracket assemblies allow the first crank and the second crank of a bicycle to be decoupled from one another so that if pressure is exerted on one pedal of the bicycle, the other pedal does not necessarily need to move in a reciprocal motion, nor does the first crank and the second crank need to be fixed one-hundred-eighty degrees apart.

In a fourth exemplary crankset and bottom bracket assembly, the crank attaches to the shaft with a ratchet wheel that has one tooth that would be caught by the pawl. The crank on the other side of the bike has the same configuration. This allows the cranks to be in the opposite position, or one crank can spin freely in the opposite direction. This is particularly useful while a cyclist is tightly turning the bike. Such an exemplary crankset and bottom bracket assembly allows a cyclist to turn the crank shaft with the outside pedal when the bike is in a turn that would not allow the inside pedal to be turned without making contact with the cycling surface.

In a fifth exemplary crankset and bottom bracket assembly, the crank attaches to the spindle of the bottom bracket axle with a ratcheting mechanism instead of a cotter, bolt, or nut.

A sixth exemplary crankset and bottom bracket assembly comprises a bicycle crankset where the crank arms are not fixed in relation to one another, but instead, the crankset has at least one ratchet assembly allowing the left crank arm to remain in one position (e.g., the upmost position) while the right crank arm is turned (and vice versa).

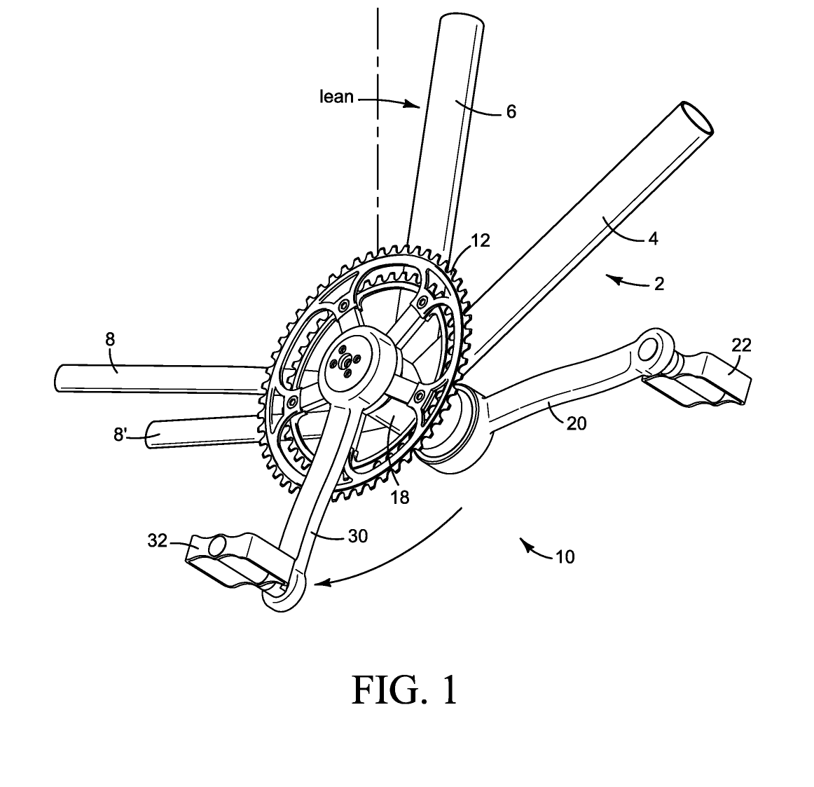

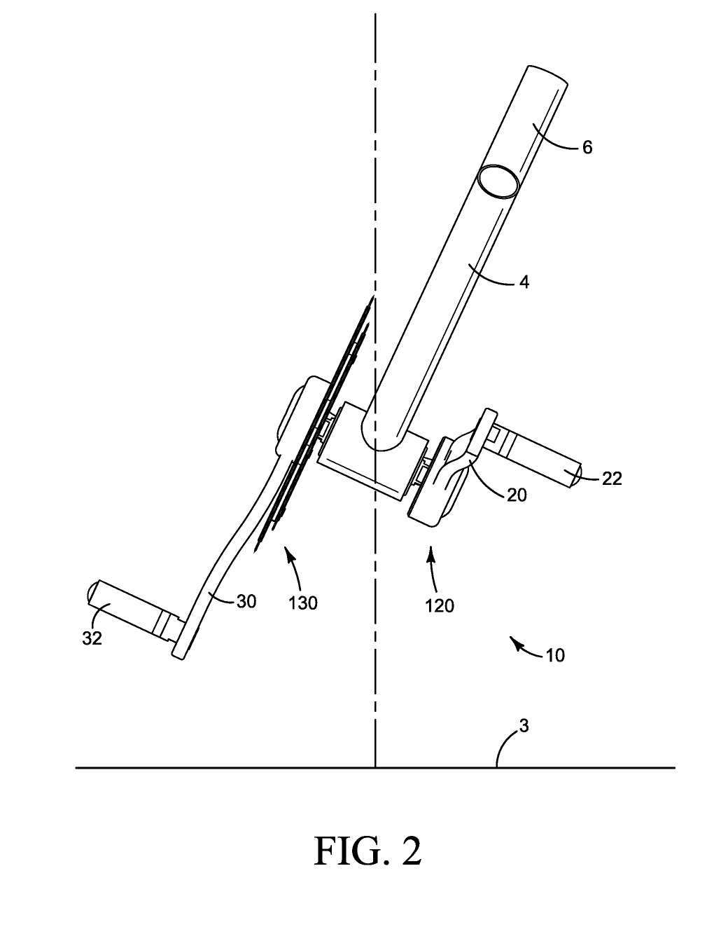

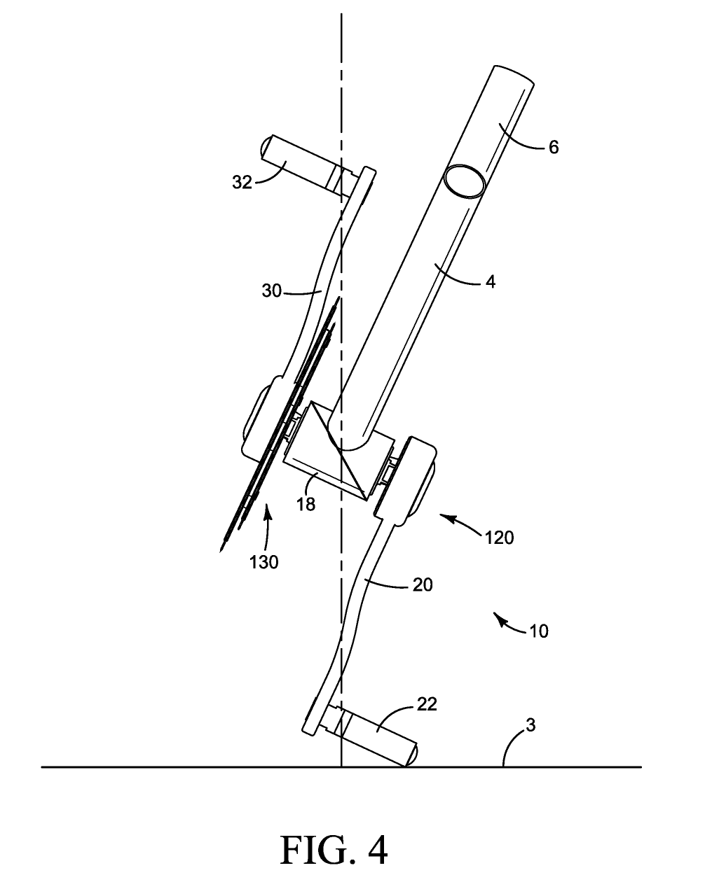

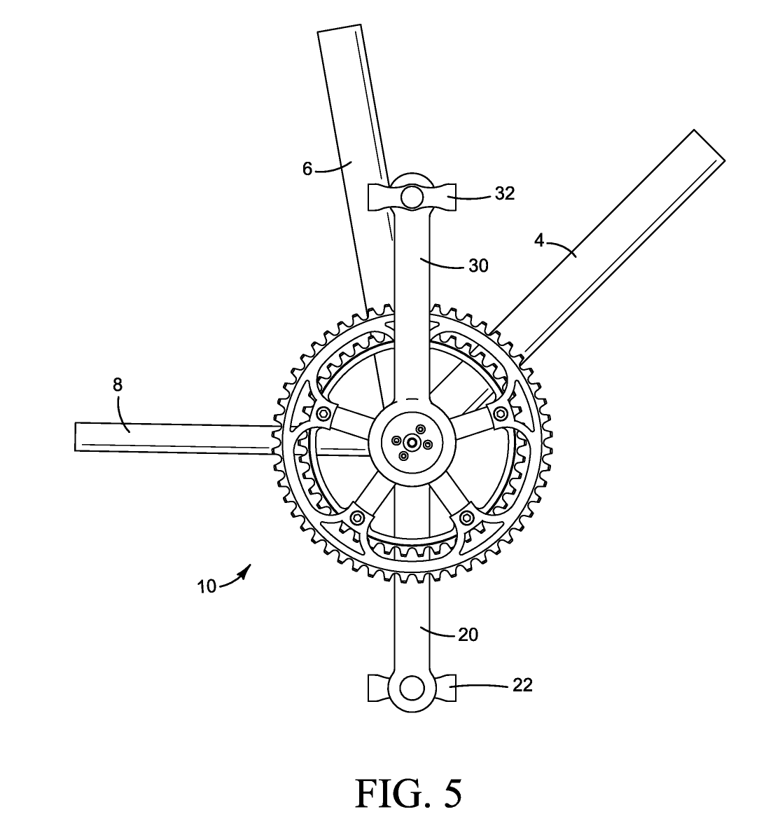

FIGS. 1 through 13 illustrate the third exemplary crankset and bottom bracket assembly 100 which is configured for use on a bicycle frame assembly. The bicycle frame assembly 2 illustrated as having a down tube 4, a seat tube 6, and a pair of chain stays 8, 8′. The bicycle frame assembly 2 further comprising a bottom bracket shell 18 configured for receiving a bottom bracket 16 therein. Other forms of bicycle frame assemblies could also be utilized.

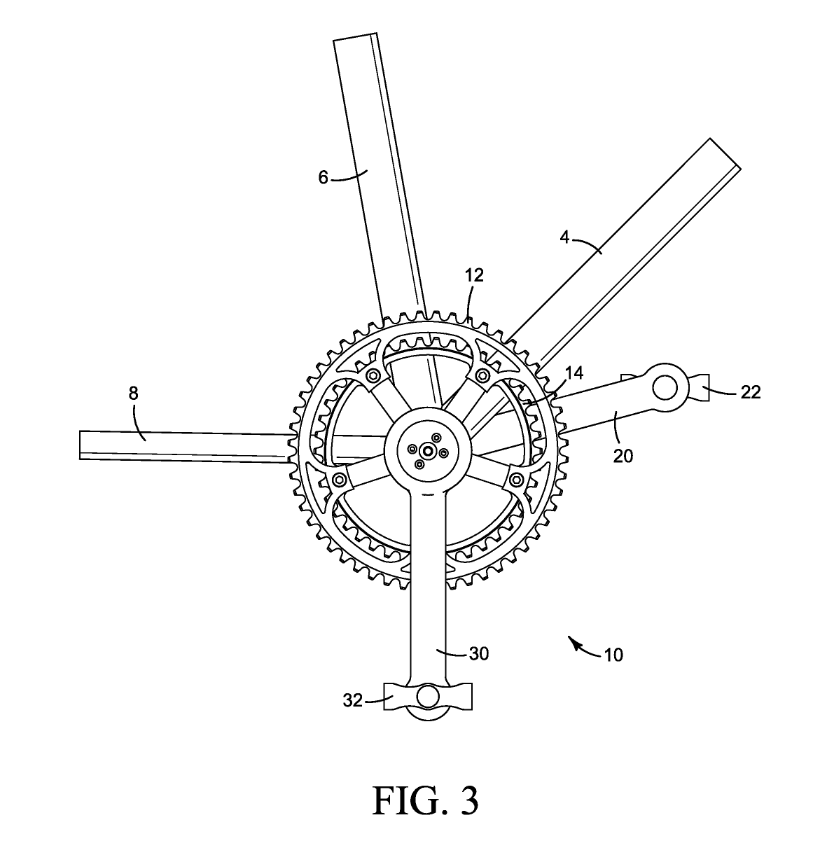

The first crank 20 and the second crank, in the third exemplary crankset and bottom bracket assembly 100, configured for being selectively decoupled from one another if so desired by the rider of the bicycle. FIGS. 1 through 5 illustrate the first crank 20 being decoupled from the second crank 30, so that the rotation of the first crank 20 can be stopped while the rotation of the second crank 30 continues, for instance, as the bicycle transits a tight corner, as particularly illustrated in FIGS. 1 through 3. But for such decoupling, as the bicycle transits such a corner (as illustrated in FIGS. 3 through 5, a pedal (such as the first pedal 22) may strike the ground surface 3, resulting in a potential crash and/or damage occurring to the bicycle or rider thereof.

In the third exemplary crankset and bottom bracket assembly 100, this decoupling is accomplished through the use of at least one ratcheting mechanism, such as ratcheting mechanism 101, and/or ratcheting mechanism 102.

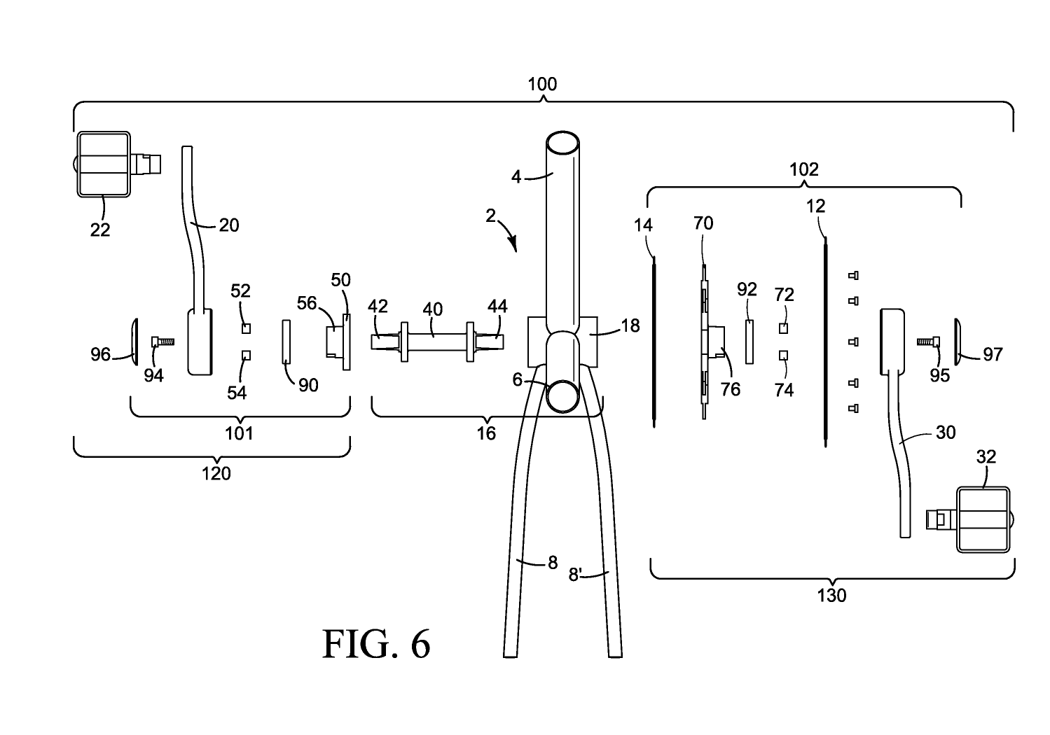

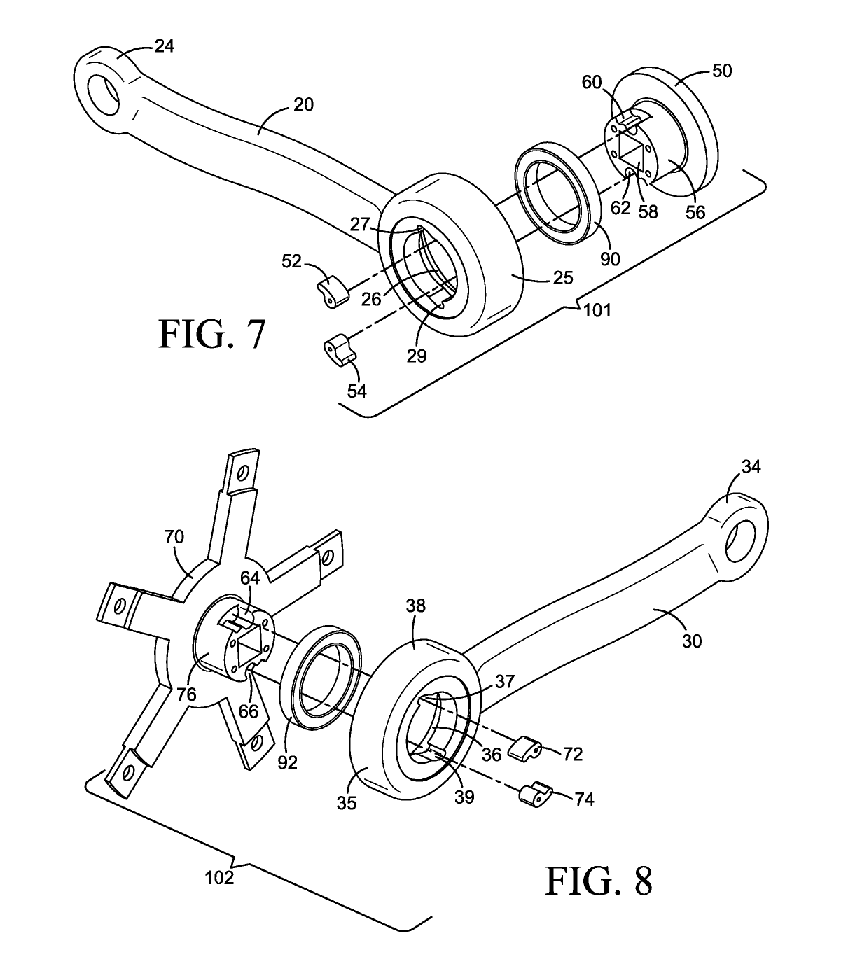

Ratcheting mechanism 101 is particularly illustrated in FIGS. 6 and 7, whereas ratcheting mechanism 102 is particularly illustrated in FIGS. 6 and 8. In these figures, the ratcheting mechanism comprises a freewheel axle with at least one tooth, and a hub receiver, having at least one pawl configured for engaging said tooth. A ratcheting mechanism can comprise any suitable configuration and structure, including, but not limited to the mechanism common in ratchet (socket) wrenches, whereby a pair of pawls cooperate with a toothed gear to accomplish a ratcheting motion. In such configuration, said pawls engage the toothed gear when rotated in one direction, and remain disengaged when rotated in the opposite direction.

In FIGS. 6 and 7, illustrated is a first crank 20 having a distal end 24 configured for connecting with a pedal 22. A shell 28 is located at an opposite end 25 of the crank 20. The shell 28 defining a hub receiver 26 configured for receiving therein an axle portion 56 of a hub 50. The hub receiver 26 configured for rotating relative to the axle portion 56. A bearing assembly 90 may be located between the hub receiver 26 and the axle portion 56. The hub receiver 26 defining at least one tooth, preferably at least a first tooth 27 and a second tooth 29, therein. These teeth (27, 29) configured for receiving therein a pawl. The axle portion 56, further comprising at least one pawl, such as first pawl 52, and second pawl 54. The first pawl 52 attaches to the axle portion 56 at a first end, and is received into pawl recess 60. The second pawl 54 attaches to the axle portion 56 at a first end, and is received into pawl recess 62. The pawls are spring biased so that their second ends rotate out of the pawl recess if not held therein.

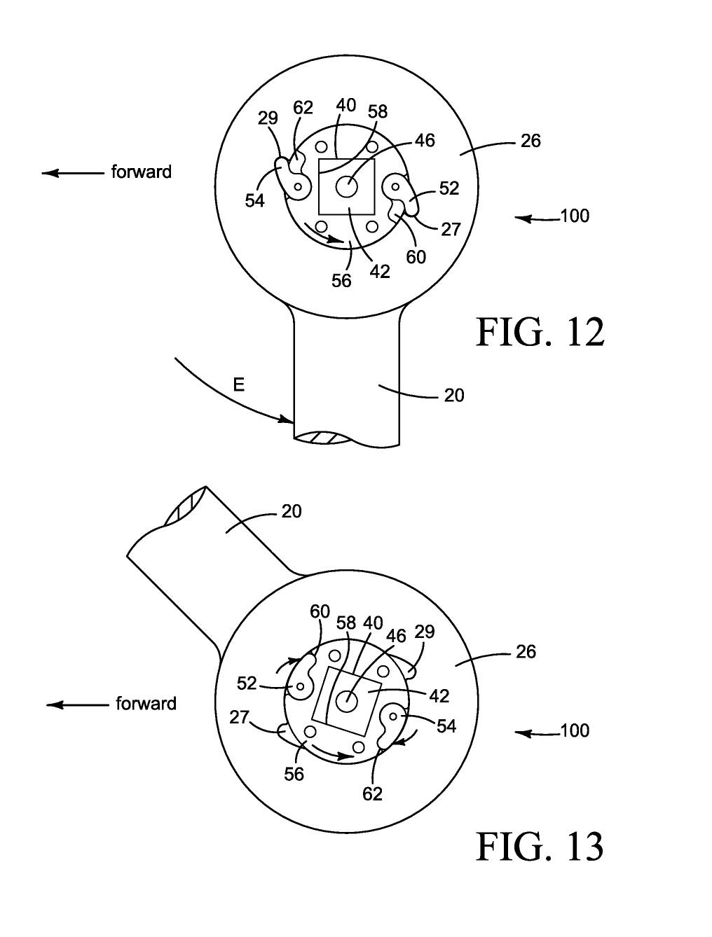

As illustrated in FIG. 12, when the hub receiver 26 is installed onto the axle portion 56, and when the hub receiver 26 is rotated relative to the axle portion 56 in an engaging direction E, the second ends of the pawls are permitted to rotate into and engage the teeth (27, 29) of the hub receiver 26, which, in turn, drives the rotation of an attached spindle 40. For instance, the second end of the first pawl 52 could engage first tooth 27, and the second end of the second pawl 54 could engage the second tooth 29. As illustrated in FIG. 13, when the hub receiver 26 is rotated relative to the axle portion 56 in a disengaging direction D, the second ends of the pawls (52, 54) disengage from the teeth (27, 29) of the hub receiver 26, and the pawls (52, 54) rotate into their respective pawl recesses (60, 62), allowing the hub receiver 26 to free wheel relative to the axle portion 56 and attached spindle 40.

In FIGS. 6 and 8, illustrated is a second crank 30 having a distal end 34 configured for connecting with a pedal 32. A shell 38 is located at an opposite end 35 of the crank 30. The shell 38 defining a hub receiver 36 configured for receiving therein an axle portion 76 of a hub 70. The hub receiver 36 configured for rotating relative to the axle portion 76. A bearing assembly 92 may be located between the hub receiver 36 and the axle portion 76. The hub receiver 36 defining at least one tooth, preferably at least a first tooth 37 and a second tooth 39, therein. These teeth (37, 39) configured for receiving therein a pawl. The axle portion 76, further comprising at least one pawl, such as first pawl 72, and second pawl 74. The first pawl 72 attaches to the axle portion 76 at a first end, and is received into pawl recess 66. The second pawl 74 attaches to the axle portion 76 at a first end, and is received into pawl recess 66. The pawls are spring biased so that their second ends rotate out of the pawl recess if not held therein.

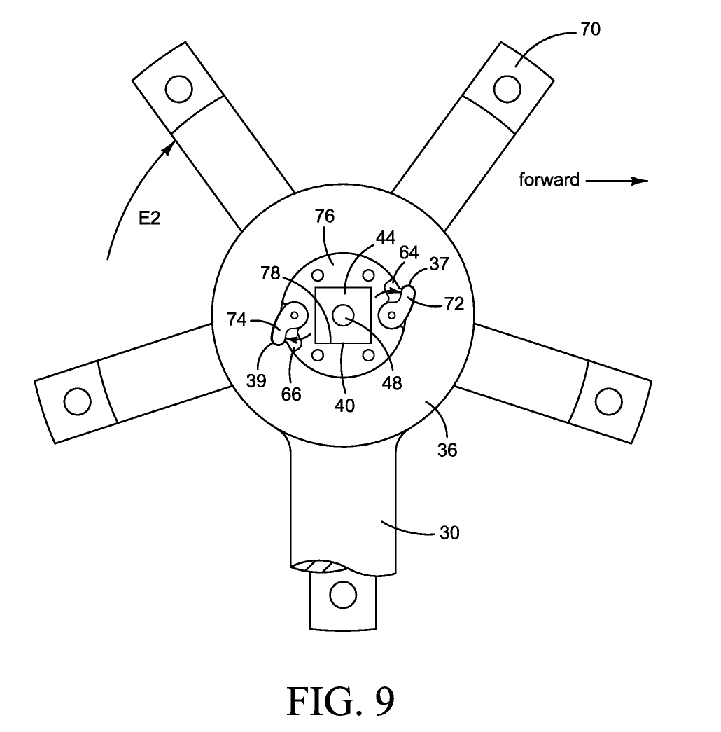

As illustrated in FIG. 9, when the hub receiver 36 is installed onto the axle portion 76, and when the hub receiver 36 is rotated relative to the axle portion 76 in an engaging direction E2, the second ends of the pawls are permitted to rotate into and engage the teeth (37, 39) of the hub receiver 26, which, in turn, drives the rotation of an attached spindle 40. For instance, the second end of the first pawl 72 could engage first tooth 37, and the second end of the second pawl 74 could engage the second tooth 39.

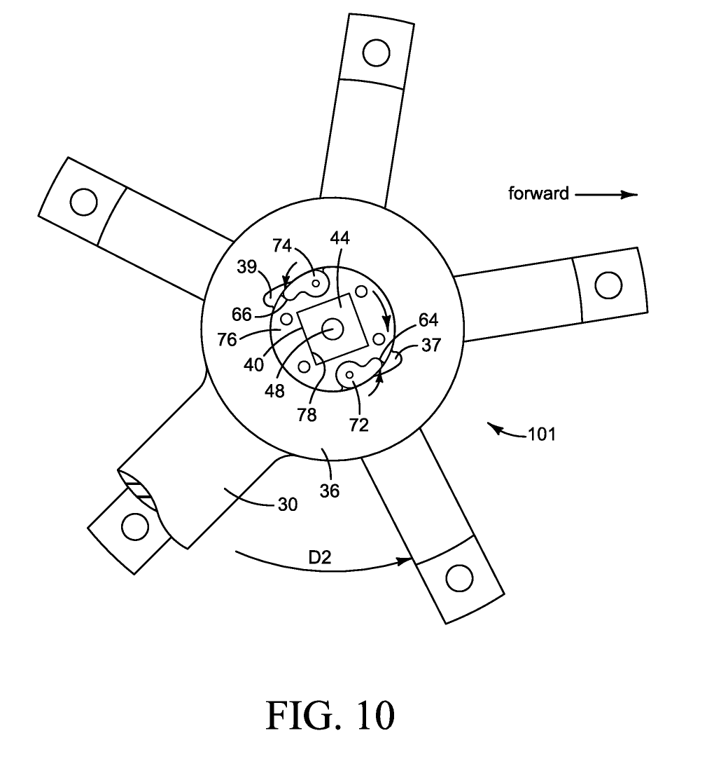

As illustrated in FIG. 10, when the hub receiver 36 is rotated relative to the axle portion 76 in a disengaging direction D2, the second ends of the pawls (72, 74) disengage from the teeth (37, 39) of the hub receiver 36, and the pawls (72, 74) rotate into their respective pawl recesses (64, 66), allowing the hub receiver 36 to free wheel relative to the axle portion 76 and attached spindle 40.

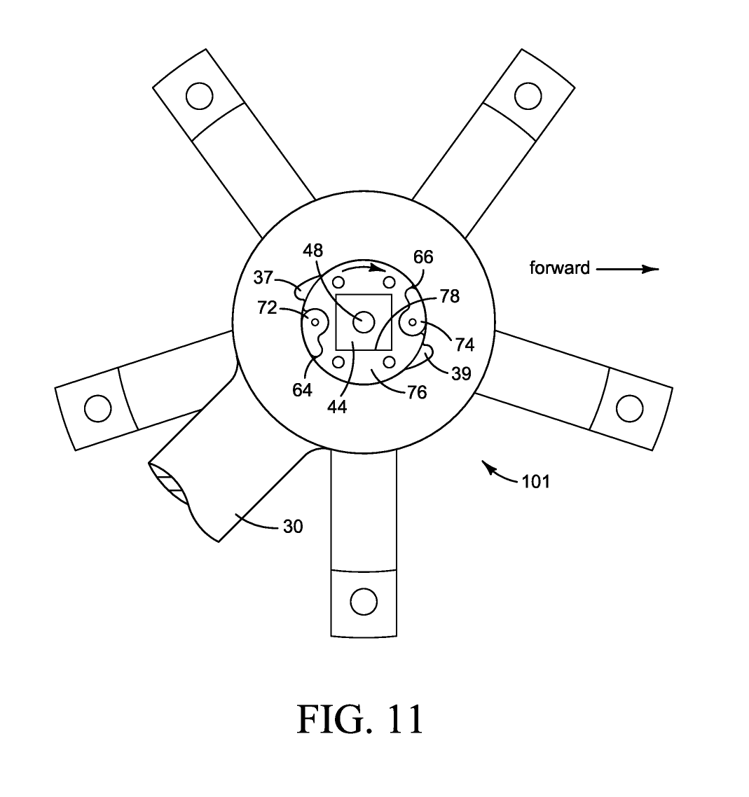

As illustrated in FIGS. 8 and 11, the second side hub 70 further comprises at least one chain ring connector assembly 80 for allowing at least one chain ring (12, 14) to be connected to the second side hub 70. In the exemplary second side hub 70 illustrated in the figures, the chain ring connector assembly 80 comprises a first arm 81, a second arm 82, a third arm 83, a fourth arm 84, and a fifth arm 85, the arms configured for attachment to the chain rings (12, 14).

Referring now to FIG. 9, when the hub receiver 36 is rotated relative to the axle portion 76 in an engaging direction E2, the second ends of the pawls (72, 74) are permitted to rotate into and engage the teeth (37, 39) of the hub receiver 36. This, in turn, drives the rotation of the spider arms, which drives the rotation of the chin rings (12, 14).

As illustrated in FIGS. 12 and 13, the first crank 20 attaches to the spindle 40 by the receiver 58 (defined in the axle portion 56 of the first side hub 50) sliding onto the spindle's first end 42. A mechanical fastener could be utilized to connect the first crank 20 to the spindle 40. For instance, after the first crank 20 is attached to the spindle 40, a bolt 94 could be threaded into a threaded passageway 46 defined in the end of the spindle first end 42. As illustrated in FIGS. 9, 10 and 11, the second crank 30 attaches to the spindle 40 by the receiver 58 (defined in the axle portion 76 of the second side hub 70) sliding onto the spindle's second end 44. A mechanical fastener could be utilized to connect the second crank 30 to the spindle 40. For instance, after the second crank 30 is attached to the spindle 40, a bolt 95 could be threaded into a threaded passageway 48 defined in the end of the spindle second end 44. Other ways of connecting the cranks to the spindle commonly used in the prior art are also possible, including, but not limited to press fits. A dust cover (96, 97) could be used to cover the connection, once assembled.

The Figures illustrate a spindle 40 having square end portions. In other exemplary crankset and bottom bracket assemblies, the spindle may have tapered, octagonal, splined, or otherwise configured ends.

In a seventh exemplary crankset and bottom bracket assembly, the assembly only comprises one ratcheting mechanism, either in the first crank or the second crank. While the bicycle still has two crank assemblies, only one crank comprises pawls capable of engaging a tooth when rotated in one direction and remaining disengaged when rotated in the opposite direction. The opposite crank remains in a fixed position. Individually, FIG. 7 or FIG. 8 could be used to represent such a single ratcheting mechanism version.

In an eighth exemplary crankset and bottom bracket assembly, the bottom bracket assembly is configured for insertion into a bracket shell of a bicycle frame and comprises a spindle. Attached to the spindle are two crank assemblies. The first assembly, comprising a first and second crank and first and second ratchet mechanism connects to the spindle at one end. This assembly, which is capable of both freewheeling and driving the bicycle, comprises a hub receiver with at least one pawl. This pawl is capable of engaging a tooth, located on the freewheel axle. When the ratchet mechanism is rotated in one direction, the pawl does not engage the tooth on the freewheel axle. Conversely, when the ratchet mechanism is rotated in the opposite direction, the pawl engages the tooth and drives the spindle, causing the bicycle to propel forward. The second crank assembly operates in the same manner. By rotating the ratchet mechanism in one direction, the pawl does not engage the tooth on the freewheel axle. Rotation in the opposite direction, however, engages the tooth and drives the spindle. Thus, the bicycle can be propelled through the use of both cranks at once, by the first crank only, or by the second crank only.

In a ninth exemplary crankset and bottom bracket assembly, the assembly is configured for insertion into a bracket shell of a bicycle frame and comprises a spindle. Attached to the spindle are two crank assemblies. The first assembly, comprising a first and second crank and first and second ratchet mechanism connects to the spindle at one end. This assembly, which is capable of both freewheeling and driving the bicycle, comprises a hub receiver with at least one pawl. This pawl is capable of engaging a tooth, located on the freewheel axle. When the ratchet mechanism is rotated in one direction, the pawl does not engage the tooth on the freewheel axle. Conversely, when the ratchet mechanism is rotated in the opposite direction, the pawl engages the tooth and drives the spindle, causing the bicycle to propel forward. The second crank assembly in this embodiment remains in a fixed position relative to the first crank. Thus, the bicycle can be propelled through the use of both cranks at once, or by the use of the first crank, only.

In a tenth exemplary crankset and bottom bracket assembly, the assembly comprises a first replacement crank arm including a ratchet mechanism configured for connection to the spindle at the first end. The first replacement ratchet mechanism comprises a freewheel axle having at least one tooth, a hub receiver having at least one pawl configured for engaging the tooth. When the ratchet mechanism is rotated in a first direction relative to the spindle, the pawl does not engage the tooth and the first crank freewheels relative to the spindle. When the first ratchet mechanism is rotated in a second direction relative to the spindle, the pawl engages the tooth and rotation of the first crank drives the rotation of the spindle. The second crank assembly comprises a second crank. The second crank is configured for connection to the spindle at the second end. When the first crank freewheels, the second crank can be utilized to drive the spindle.

In an eleventh exemplary crankset and bottom bracket assembly, the assembly comprises a first replacement crank arm including a ratchet mechanism configured for connection to the spindle at the first end and a second replacement crank arm including a ratchet mechanism configured for connection to the spindle at the second end. The first replacement ratchet mechanism comprises a freewheel axle having at least one tooth, a hub receiver having at least one pawl configured for engaging the tooth. When the ratchet mechanism is rotated in a first direction relative to the spindle, the pawl does not engage the tooth and the first crank freewheels relative to the spindle. When the first ratchet mechanism is rotated in a second direction relative to the spindle, the pawl engages the tooth and rotation of the first crank drives the rotation of the spindle. The second replacement crank assembly comprises a second crank. The second replacement crank is configured for connection to the spindle at the second end. When the first crank freewheels, the second crank can be utilized to drive the spindle.

Exemplary crankset and bottom bracket assemblies could be utilized in competitive bicycle racing—installed on a bicyclist's competition bike that is used for training and competing. Such training and competition includes, but is not limited to, road cycling and mountain biking. Exemplary crankset and bottom bracket assemblies could also be utilized with exercise bicycles and any other type of stationary bicycle.

In a twelfth exemplary crankset and bottom bracket assembly, the hub receiver or pawl could be located in either the crank or hub, so long as the crank comprises either the hub receiver or pawl and the hub comprises the opposite device.

In a thirteenth exemplary crankset and bottom bracket assembly, the crank may be connected to the hub through the use of either a bearing or bushing.

Any suitable structure and/or material can be used for the crankset and bottom bracket assembly, and a skilled artisan will be able to select an appropriate structure and material for the crankset and bottom bracket assembly in a particular embodiment based on various considerations, including the intended use of the crankset and bottom bracket assembly, the intended arena within which the crankset and bottom bracket assembly will be used, and the equipment and/or accessories with which the crankset and bottom bracket assembly is intended to be used, among other considerations.

The foregoing detailed description provides exemplary embodiments of the invention and includes the best mode for practicing the invention. The description and illustration of these embodiments is intended only to provide examples of the invention, and not to limit the scope of the invention, or its protection, in any manner.

What is claimed is:

1. A crankset for a bicycle having a bottom bracket assembly comprising a spindle having a spindle first end and a spindle second end, said crankset comprising:
a first crank assembly comprising a first crank, said first crank comprising a first ratchet mechanism configured for connection to said spindle first end, wherein when said first ratchet mechanism is rotated in a first direction relative to the spindle, said first crank freewheels relative to said spindle, and wherein when said first ratchet mechanism is rotated in a second direction relative to the spindle, rotation of said first crank drives the rotation of said spindle.

2. The crankset of claim 1, wherein said first ratchet mechanism comprises a freewheel axle having at least one tooth.

3. The crankset of claim 2, wherein said first ratchet mechanism comprises a hub receiver having at least one pawl configured for engaging said tooth.

4. The crankset of claim 1, wherein said first ratchet mechanism comprises a freewheel axle having at least one tooth, and wherein said first ratchet mechanism comprises a hub receiver having at least one pawl configured for engaging said tooth.

5. The crankset of claim 4, wherein when said first ratchet mechanism is rotated in a first direction relative to the spindle, the pawl does not engage said tooth.

6. The crankset of claim 5, wherein when said first ratchet mechanism is rotated in a second direction relative to the spindle, the pawl engages said tooth.

7. The crankset of claim 1, further comprising a second crank assembly comprising a second crank, said second crank comprising a second ratchet mechanism configured for connection to said spindle second end, wherein when said second ratchet mechanism is rotated in a third direction relative to the spindle, said second crank freewheels relative to said spindle, and wherein when said second ratchet mechanism is rotated in a fourth direction relative to the spindle, rotation of said second crank drives the rotation of said spindle.

8. The crankset of claim 7, wherein said second ratchet mechanism comprises a second freewheel axle having at least one second tooth, and a second hub receiver having at least one second pawl configured for engaging said second tooth.

9. The crankset of claim 8, wherein when said second ratchet mechanism is rotated in a third direction relative to the spindle, the pawl does not engage said second tooth and said second crank freewheels relative to said spindle.

10. The crankset of claim 8, wherein when said second ratchet mechanism is rotated in a fourth direction relative to the spindle, the second pawl engages said second tooth and rotation of said second crank drives the rotation of said spindle.

11. The crankset of claim 8, wherein when said second ratchet mechanism is rotated in a third direction relative to the spindle, the pawl does not engage said second tooth and said second crank freewheels relative to said spindle; and wherein when said second ratchet mechanism is rotated in a fourth direction relative to the spindle, the second pawl engages said second tooth and rotation of said second crank drives the rotation of said spindle.

12. The crankset of claim 1, further comprising a second crank assembly comprising a second crank, said second crank comprising a second ratchet mechanism configured for connection to said spindle second end;
wherein said first ratchet mechanism comprises a freewheel axle having at least one tooth, and a hub receiver having at least one pawl configured for engaging said tooth; wherein when said first ratchet mechanism is rotated in a first direction relative to the spindle, the pawl does not engage said tooth; wherein when said first ratchet mechanism is rotated in a second direction relative to the spindle, the pawl engages said tooth; and
wherein said second ratchet mechanism comprises a second freewheel axle having at least one second tooth, and a second hub receiver having at least one second pawl configured for engaging said second tooth; wherein when said second ratchet mechanism is rotated in a third direction relative to the spindle, the pawl does not engage said second tooth and said second crank freewheels relative to said spindle; and wherein when said second ratchet mechanism is rotated in a fourth direction relative to the spindle, the second pawl engages said second tooth and rotation of said second crank drives the rotation of said spindle.

13. The crankset of claim 1, further comprising at least one chain ring.

14. The crankset of claim 1, wherein said first crank assembly further comprises a pedal.

15. A crankset and bottom bracket assembly, said assembly comprising:
a bottom bracket assembly configured for insertion into a bracket shell of a bicycle frame, said bottom bracket assembly comprising a spindle having a first end and a second end;
a first crank assembly comprising a first crank, said first crank comprising a first ratchet mechanism configured for connection to said spindle at said first end, said first ratchet mechanism comprising a freewheel axle having at least one tooth, and a hub receiver having at least one pawl configured for engaging said tooth, wherein when said first ratchet mechanism is rotated in a first direction relative to the spindle, the pawl does not engage said tooth and said first crank freewheels relative to said spindle, and wherein when said first ratchet mechanism is rotated in a second direction relative to the spindle, the pawl engages said tooth and rotation of said first crank drives the rotation of said spindle; and
a second crank assembly comprising a second crank, said second crank configured for connection to said spindle at said second end, wherein when said first crank freewheels, said second crank drives said spindle.

16. The crankset and bottom bracket assembly for claim 15, wherein said second crank comprises a second ratchet mechanism configured for connection to said spindle at said second end, said second ratchet mechanism comprising a freewheel axle having at least one tooth, and a hub receiver having at least one pawl configured for engaging said tooth;
wherein when said second ratchet mechanism is rotated in a third direction relative to the spindle, the pawl of said second ratchet mechanism does not engage the tooth of said second ratchet mechanism, and said second crank freewheels relative to said spindle; and
wherein when said second ratchet mechanism is rotated in a fourth direction relative to the spindle, the pawl engages the tooth of said second ratchet mechanism and rotation of said second crank drives the rotation of said spindle.

17. The crankset and bottom bracket assembly for claim 16, wherein said first direction and said third direction are the same direction relative to said spindle, and wherein said second direction and said fourth direction are the same direction relative to said spindle.

18. A crankset and bottom bracket assembly, said assembly comprising:
a bottom bracket assembly configured for insertion into a bracket shell of a bicycle frame, said bottom bracket assembly comprising a spindle having a first end and a second end;
a first crank assembly comprising a first crank, said first crank comprising a first ratchet mechanism configured for connection to said spindle at said first end, said first ratchet mechanism comprising a first freewheel axle having at least one first tooth, and a first hub receiver having at least one first pawl configured for engaging said first tooth, wherein when said first ratchet mechanism is rotated in a first direction relative to the spindle, the first pawl does not engage said first tooth and said first crank freewheels relative to said spindle, and wherein when said first ratchet mechanism is rotated in a second direction relative to the spindle, the first pawl engages said first tooth and rotation of said first crank drives the rotation of said spindle; and
a second crank assembly comprising a second crank, said second crank comprising a second ratchet mechanism configured for connection to said spindle at said second end, said second ratchet mechanism comprising a second freewheel axle having at least one second tooth, and a second hub receiver having at least one second pawl configured for engaging said second tooth, wherein when said second ratchet mechanism is rotated in a third direction relative to the spindle, the pawl does not engage said second tooth and said second crank freewheels relative to said spindle, and wherein when said second ratchet mechanism is rotated in a fourth direction relative to the spindle, the second pawl engages said second tooth and rotation of said second crank drives the rotation of said spindle.

19. The crankset and bottom bracket assembly for claim 18, wherein said first direction and said third direction are the same direction relative to said spindle, and wherein said second direction and said fourth direction are the same direction relative to said spindle.

20. The crankset of claim 18, wherein said first crank assembly further comprises a first pedal, and wherein said second crank assembly further comprises a second pedal.
